(19) United States
(12) Patent Application Publication
(10) Pub. No.: US 2009/0310593 A1
(43) Pub. Date: Dec. 17, 2009

(54) SELF-POSITIONING ACCESS POINTS

(75) Inventors: Leonid Sheynblat, Hillsborough, CA (US); Ardalan Heshmati, Saratoga, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/140,634

(22) Filed: Jun. 17, 2008

(51) Int. Cl. H04J 3/06

(52) U.S. Cl. 370/350

(57) ABSTRACT

A system, method and apparatus are provided which relate to calibrating a wireless access point so as to allow proper synchronization of mobile wireless devices connecting to the wireless access point. A closed-loop filter is used to more accurately synchronize times and to more accurately determine the location of the access point for purposes of determining the position of a mobile station.

### BACKGROUND

The operation of a mobile communication device (hereinafter referred to as a mobile station) is sometimes compromised by the inability to establish a good communication link with a base transceiver station (BTS). This may be especially problematic within a closed-in environment such as a building in an urban setting with surrounding tall buildings. Failure to obtain a good communications link deprives the mobile station user of many of the services available through the mobile station such as the ability to determine the geographic position of the mobile station, etc. Mobile phones have had the capability of using alternate communication methods in the past such as those allowing the use of the Advanced Mobile Phone Service (AMPS), an analog system, when a digital communication system is unavailable within a geographic area. However, even AMPS systems are subject to a poor communication link with a BTS.

Wireless Local Area Networks (WLANs) enable users of wireless devices to wirelessly connect to an access point (e.g., hotspot) which often acts as a bridge connecting a wireless network to the Internet through a Wide Area Network (WAN) provided by an Internet Service Provider (ISP). Wi-Fi networks typically use one or more crystal oscillator reference clocks which may, for instance, clock data exchanged between an ISP's WAN and a WLAN device connected wirelessly to an access point. The reference clock at the access point typically employs a voltage controlled oscillator using a crystal clock. Low phase noise and frequency stability provided by the reference clock is necessary to ensure wireless communication between client devices and the access point. Nevertheless, reference clocks will drift which affects the proper synchronization of WLAN devices.

A need exists to ensure minimal reference clock drift and properly maintained absolute time for WLAN reference clocks. These requirements are especially important for mobile devices such as mobile phones in order to allow them to properly sync up with an ad hoc network through a hotspot.

Lately, phones have been developed with capability to access wireless local area networks. In addition, locating property, people (including employees), etc. has become a matter of increased importance over the last several years, especially where it involves doing so through the medium of a mobile phone. Several technologies are available and have been proposed for mobile station position determination ranging from use of a Satellite Positioning System (SPS), proximity methods and propagation and time of arrival measurements in addition to other network-based solutions. As used herein, a mobile station (MS) refers to a device such as a cellular or other wireless communication device, personal communication system (PCS) device, personal navigation device, laptop or other suitable mobile device capable of receiving and processing SPS signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile station.”

Fingerprinting provides one approach to determining the position of a mobile station. Radio frequency signal characteristics associated with various regions in a signal transmission area are collected in a database. Each grouping of signal characteristics for a region is known as a fingerprint. Typically, the position of a mobile station is determined by comparing a RF data sample collected by the mobile station to fingerprint data in the database. The mobile station's position is determined to lie in the area corresponding to a fingerprint data point of highest correlation to the RF data sample.

Received signal strength intensity (RSSI) has been used in connection with network planning and fingerprinting. Radio network sample points are collected from different site locations. Each sample point contains RSSI data together with related map coordinates which are stored in a database for position tracking of persons, assets, equipment, etc. within a Wi-Fi network (IEEE 802.11 a/b/g), WiMAX network (IEEE 802.16), etc. These networks may use a program running on a server that calculates position determinations and interacts with a client device (i.e., laptop computer, personal digital assistant (PDA), Wi-Fi Tag, etc.) in connection with an application program for recording field data (e.g., RSSI data). The position determination data returned may include the speed, heading, building floor and grid location of a client device. For larger scale applications, a mobile phone's location may be determined using RSSI measurements for trilateration made in connection with data measured from several access points.

When WLAN base stations (also known as Access Points for IEEE 802.11 networks) are used in connection with mobile station position determination, with the exception of signature-based methods, accurate knowledge of the base station location is necessary in connection with using many of the foregoing described position determination methodologies. In fact, knowledge of access point positioning may have a profound effect on the overall functionality of a mobile station. An important consideration centers on accurate timing information and synchronization in connection with the receipt of packet information in a packet network.

A need exists to provide accurate and synchronized timing to a mobile station even in the event of an otherwise unsuitable or unavailable communication link with a BTS.

### BRIEF DESCRIPTION OF THE DRAWINGS

FIG. 1 illustrates a block diagram of a system implementing a Kalman Filter, in connection with synchronization of an access point.

FIG. 2 illustrates a flowchart illustrating the operation of the recursive filter in the calibration of the access point clock and the synchronization of the access point time signals in connection with the NTP time signals received over the Internet

FIG. 3 illustrates a diagram of a system employing a website for mobile station position determination and navigation. Reference numbers have been carried forward.

### DETAILED DESCRIPTION

Methodologies are provided herein for enabling timing synchronization and obtaining accurate timing information for a mobile station in instances in which a wireless communication link is either not available or inadequate with a BTS using the mobile station's primary communication resources. In this regard, a secondary communication link using a Wi-Fi (e.g., IEEE 802.11) or Bluetooth connection to WLAN or Personal Area Network (PAN) base station may be relied upon for connection to the Internet using an Internet protocol (IP). Throughout herein, WiFi and 802.11 are considered and used interchangeably. Mobile stations having dual digital and AMPS capability have been contemplated and would benefit from the disclosure herein.

Given that the internal reference clock located at an access point (which may include, for instance a Digital Subscriber Line (DSL) Modem and a DSL port and/or a cable modem) is subject to drift, one method for maintaining proper clock timing involves synchronizing the clock with a reliable outside time source.

Accurate timing synchronization for the access point clock may be derived from timing information received through the access point from the ISP's WAN which may be connected to a server implementing the Network Time Protocol (NTP). NTP uses Marzullo's algorithm with the Coordinated Universal Time (UTC) time scale, including support for features such as leap seconds. NTP version 4 (NTPv4) has been shown to maintain time to within 10 milliseconds over the Internet. Further, NTP can achieve accuracies to within 200 microseconds or better in some instances running on a local area network. NTP is implemented using a hierarchical system of clock strata. The stratum levels define the distance in the hierarchical scheme from the reference clock and the associated accuracy. Timing drift at stratum 1 devices may be less than that at other strata. Nevertheless, drift will result when sourcing timing information from various clock stratum levels.

In connection with establishing proper functionality of a mobile station connected by a wireless link to an 802.11 network access point, synchronization of the access point clock oscillator may occur with the accurate time provided over the Internet.

Techniques may be used to model clock error such as those disclosed by E. Filho, H. Kuga and R. Lopes. 2003 in Real Time Estimation of GPS Receiver Clock Offset by the Kalman Filter, Proceedings of COBEM 2003, 17^{th} International Congress of Mechanical Engineering, which is hereby incorporated by reference.

As disclosed by Filho, Kuga and Lopes, as referenced above, a recursive filter such as a Kalman filter may be used to synchronize a clock. Therefore such a filter may be used to synchronize an access point clock with the NTP time provided through the Internet. The Kalman filter may present a real time state estimation problem as a set of mathematical equations for which a recursive solution is available. Consequently, the Kalman filter is a recursive estimator which estimates the current state from the previous time step and current measurements. It uses a predict phase and an update phase. The predict phase uses the state estimate from the previous time step to produce an estimate of the state at the current time step. In the update phase, measurement information at the current time step is used to refine this prediction to arrive at a new state estimate which is intended to have greater accuracy, again for the current time step.

At time k an observation (or measurement) yₖ of the true state xₖ of the NTP clock signal is made according to

yₖ=Hₖxₖ+vₖ

where vₖ=N(0, Rₖ(t))

Hₖ, is a m×n observation matrix for each time step k, that provides a state transition model for the previous state xₖ₋₁. Consequently, it maps the true state space into the observed space.

vₖ is the observation white noise which is assumed to have a Gaussian distribution with zero mean and covariance matrix Rₖ(t).

The predicted state is defined as

\hat{x}=Fx

with covariance matrix P and

F being a state transition model applied to the previous state. By differencing the time of arrival of timing pulses, a timing drift of an external source can be computed. This is reflected in the model for the update equations state which is as follows:

Δₖ=yₖ−Hₖ\hat{x}ₖ

where Δₖ represents the measurement residual by which the predicted state determined from the previous measured state differs from the current measured state.

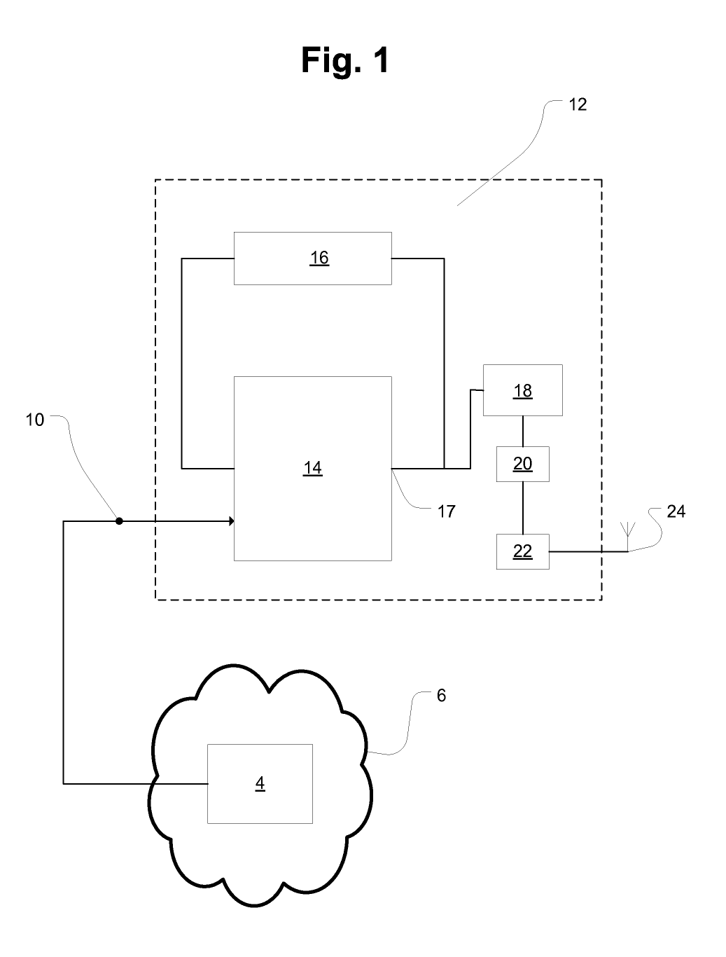

With reference to FIG. 1, which illustrates a block diagram of a system implementing a Kalman Filter, a time signal from a NTP server 4 is transmitted through an ISP's WAN 6 using the Internet. Input 10 of access point 12, which receives the time signal and inputs it to filter section 14 which determines the predicted state of the time signal. Filter sections 14 and 16 collectively form a Kalman Filter. Filter section 16 determines the update equations state for feedback of the measurement residual to filter section 14. This process continues, resulting in what is intended to be successively better clock pulse predictions for synchronization of the access point's internal frequency source 18 (e.g., a crystal oscillator) with the clocking signals received through the Internet. In effect, the access point frequency source 18 (or clock) may be self-positioning. From time to time, the filter output at 17 from filter section 14, with contribution from feedback through filter section 16, is used to calibrate, using processor 22, and internal frequency source 18 which clocks signals through transceiver 20. This calibration may occur continuously.

Alternatively, processor 22 may represent a hardware device. An effective NTP time source may be effectively provided at a WLAN access point, thereby enabling proper mobile station functionality especially in instances where a connection with a primary network is not possible and where a WI-Fi network is relied upon for communications involving devices connecting to access point 12 through antenna 24.

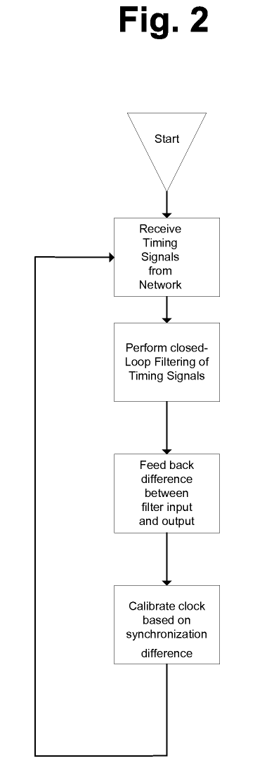

FIG. 2 is a flowchart illustrating the operation of the recursive filter in the calibration of the access point clock and the synchronization of the access point time signals with the NTP time signals received over the Internet. The received network time signal is closed-loop filtered until the difference between filter output and input becomes zero. The access point clock is calibrated based on this information. This methodology continues as newly received network time signals are input to the filter

Once the mobile station connects, via Wi-Fi link, to an access point within, for instance, a building, a substantial amount of functionality can be restored to the mobile station despite the fact that a communication link is not possible through a primary communication methodology using for instance, Code Division Multiple Access (CDMA), Wideband Code Division Multiple Access (WCDMA), Time Division Multiple Access (TDMA), Global System for Mobile Communications (GSM), AMPS, Frequency Division Multiple Access (FDMA), etc. This functionality may be greatly enhanced with the foregoing synchronization scheme which also allows an enhanced knowledge of the access point clock's absolute time and timing drift. For instance, position determination of and navigation with a mobile station may be greatly facilitated through synchronization and knowledge of absolute timing acquired through use of the foregoing Kalman filtering scheme using several methods. Assuming that the mobile station has established a communication link through a fixed-location access point, the mobile station's location position may be approximated as that of the access point. Alternatively, the mobile station's position may be determined using time of arrival, RSSI, etc. methods. Still alternatively, the mobile station's position may be determined using the afore-mentioned methods including instances where the access point is itself mobile and not fixed.

In some aspects, mobile station position determination and mobile navigation requests may be handled in connection with directing navigation related requests to a website wherein a program may make navigation and position determinations based upon data collected through an Internet or an intranet connection to the access point.

Entry through an access point may only be provided to selected users. For instance, subscribers to a given phone service, e.g., Verizon®, Sprint®, etc. may be the only ones allowed to connect to a WAN through an access point. Since the 802.11 network may take the mobile station off-line from the conventional billing mechanism, billing for services in connection with the 802.11 network may occur using a variety of methods based on ad hoc service requests, monthly rates for a package of services, etc. Alternatively, a connection through an access point may be made to a virtual private network based on various criteria.

Voice and other data communications may be conducted using the Wi-Fi connection to an access point using the Internet, as further facilitated by the foregoing Kalman filtering scheme. Additionally, a handoff scheme may be used to switch a call in service to a primary communication network once wireless communications with that network become available.

In some aspects, position determination for a mobile station may occur based on time of arrival (TOA) ranging wherein measurement occurs of the arrival time, at the mobile station receiver, of a known signal that has been transmitted at a known time from an access point. The difference between the arrival time and the transmitted time, i.e. the propagation time, of the known signal is multiplied by the speed of light in order to obtain the signal propagation distance between the signal emitter and the mobile station receiver, i.e., the emitter-to receiver range. The position of the mobile station may be determined in connection with measuring the propagation time of signals broadcast from multiple signal emitters at access points at known locations. The signal propagation distance between each signal emitter and the mobile station receiver is commonly referred to as a pseudo range. Three such pseudo ranges provide three unknown position coordinates that may be determined in three simultaneous equations, thereby allowing the mobile station's position to be determined by well-known methods using trilateration.

A number of features executed by a mobile station with an active link to a BTS may be carried out by a mobile station connected to an 802.11 network such as Voice-Over Internet Protocol (VOIP) with many of its attendant features. With reference to FIG. 1, a processor (not shown) within mobile station 15 will cause mobile station 15 to change it's functionality from operation through a primary network involving a BTS to a secondary network using Wi-Fi in the event that connectivity to the primary network is unavailable. In addition, this processor (not shown) may shift mobile station 15 back to functionality through the primary network upon the establishment of a suitable communication link between mobile station 15 and the primary network. Further, mobile station position determination and navigation service may be offered through the mobile station in connection with the foregoing.

Although in one aspect, the position of the mobile station may be assumed to be the same as that of the known fixed position of the access point to which it is connected, should the mobile station receive signals from more than one access point, the location of the access point having the greatest received signal strength link with the mobile station may be used as indicating the position of the mobile station. Furthermore, knowledge of the transmit power can be sued to ascertain the distance traveled therefore placing the mobile station on the circle around the location of the access point with the radius equal to the distance traveled.

In another aspect, the position of the mobile station is determined in connection with signal analysis in relation to a plurality of access points using well known position determination techniques, e.g. trilateration and/or triangulation.

Position determination and navigation requests may require analysis utilizing resources outside of the mobile station. Consequently, should a position or navigation request be made from a mobile station not in contact with its primary network, the request may be handled through an access point using the Internet, the Internet including a Virtual Private Network (VPN), an Intranet or ATM through which an access point provides a connection. For instance, relevant signal data from the mobile station may be forwarded to an Internet Protocol (IP) address.

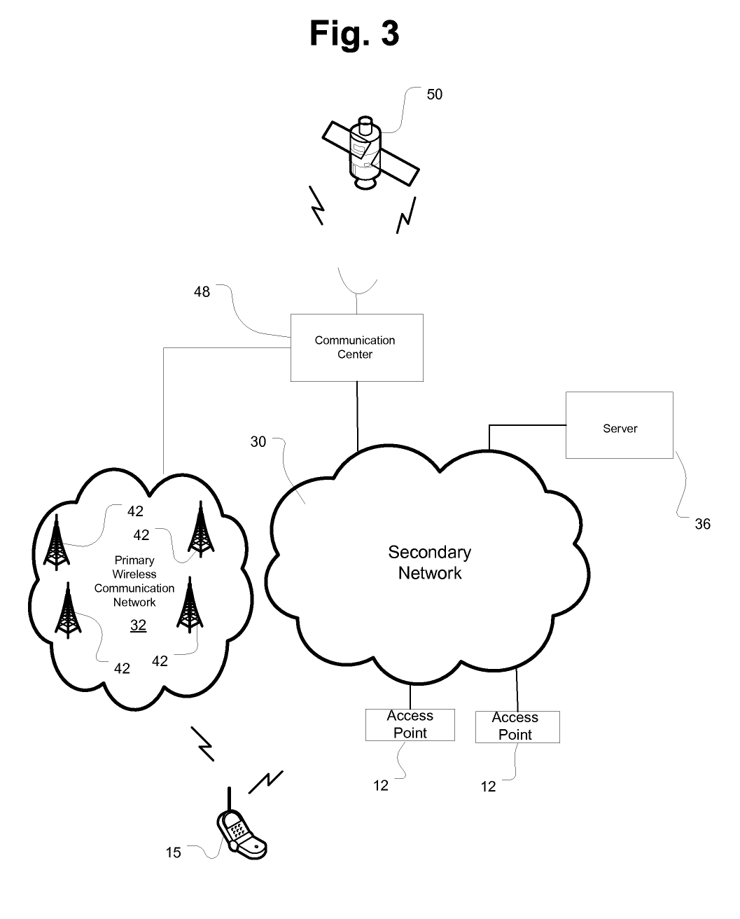

FIG. 3 illustrates a diagram of a system employing a website for mobile station position determination and navigation. In connection with mobile station 15 being in communication with secondary network 30 rather than primary wireless communications network 32, assuming that mobile station 15 has been synchronized with secondary network 30 according to one of the foregoing discussed methods, relevant signal data, e.g. RSSI, TOA information, etc. is forwarded to a designated IP address via, Internet, intranet and/or ATM through an access point 12. The designated IP address may be that of server 36 which may be dedicated to handling position determination or navigation requests (i.e. step-by-step directions for traveling between a designated destination and a determined location or position). Server 36 may respond to position determination or navigation requests back through secondary network 30 through an access point 12 and/or it may respond through primary network 32 using a BTS 42 in event that mobile station 15 reestablishes contact with primary network 32. In addition, communication center 48 may enable satellite communications through satellite 50 to supplement communications involving secondary network 30 and primary network 32. Further, server 36 may handle aspects of mobile station feature requests and billing for service provided to mobile station 15.

Position and navigation determinations may be made in connection with using RSSI, fingerprinting, trilateration, triangulation, etc. with the analysis of signals received at the mobile station or from the mobile station being performed at server 36 through the forwarding of data to an access point 12. Position determination techniques described herein may be used for various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN.

The method and apparatus described herein may be used with various satellite positioning systems (SPS), such as the United States Global Positioning System (GPS), the Russian Glonass system, the European Galileo system, any system that uses satellites from a combination of satellite systems, or any satellite system developed in the future. Use of the term SPS is contemplated to include a Global Positioning System (GPS), Galileo, GLONASS, NAVSTAR, GNSS, a system that uses satellites from a combination of these systems, or any SPS developed in the future. As used throughout, SPS will also be understood to include pseudolite systems.

Furthermore, the disclosed method and apparatus may be used with positioning determination systems that utilize pseudolites or a combination of satellites and pseudolites. Pseudolites are ground-based transmitters that broadcast a PN code or other ranging code (similar to a GPS or CDMA cellular signal) modulated on an L-band (or other frequency) carrier signal, which may be synchronized with GPS time. Each such transmitter may be assigned a unique PN code so as to permit identification by a remote receiver. Pseudolites are useful in situations where GPS signals from an orbiting satellite might be unavailable, such as in tunnels, mines, buildings, urban canyons or other enclosed areas. Another implementation of pseudolites is known as radio-beacons. The term “satellite”, as used herein, is intended to include pseudolites, equivalents of pseudolites, and possibly others. The term “SPS signals”, as used herein, is intended to include SPS-like signals from pseudolites or equivalents of pseudolites.

The methodologies described herein may be implemented by various means depending upon the application. For example, these methodologies may be implemented in hardware, firmware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof For a firmware and/or software implementation, the methodologies may be implemented with modules (e.g., procedures, functions, and so on) that perform the functions described herein. Any machine readable medium tangibly embodying instructions may be used in implementing the methodologies described herein. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

In one or more exemplary aspects, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although a description has been given with reference to particular aspects, it is to be understood that these embodiments are merely illustrative of the principles and applications. For instance, the foregoing is contemplated as being implemented entirely in software. It is therefore to be understood that numerous modifications may be made to the illustrative embodiments and that other arrangements may be devised without departing from the spirit and scope as defined by the appended claims. For instance, the foregoing is contemplated as being implemented entirely in software

1. An access point for a wireless network comprising:
a clock configured to generate clock timing signals;
a closed-loop filter coupled to said clock, said filter configured to cause synchronization of said clock timing signals with timing signals received from a network connected to the Internet; and
a processor configured to calibrate said clock.

2. An access point as recited in claim 1 wherein said filter is further operable to output timing offsets of said clock timing signals from timing signals received from a network connected to the Internet.

3. An access point as recited in claim 1 wherein the filter is a Kalman filter.

4. An access point as recited in claim 1 wherein said network is a Wide Area Network.

5. An access point as recited in claim 1 wherein said timing signal received from said network connected to the Internet are generated by a server implementing the Network Time Protocol.

6. An access point as recited in claim 1 wherein said processor is capable of calibrating said clock through use of hardware.

7. An access point as recited in claim 1 wherein said processor is capable of calibrating said clock through use of software.

8. An access point as recited in claim 1 wherein said timing signals received from said network connected to the Internet are synchronized with timing signals generated by a satellite positioning system.

9. An access point as recited in claim 8 wherein said satellite positioning system consists of GPS, Galileo, GLONASS, NAVSTAR, GNSS or a combination thereof.

10. A method of synchronizing a wireless network access point comprising:
receiving a timing signal from a satellite positioning system time source;
Kalman filtering said timing signal; and
calibrating a wireless access point clock using output from said Kalman filtering.

11. A method as recited in claim 10 wherein said timing signal is generated by a source implementing the Network Time Protocol.

12. A computer program product stored on a tangible medium that stores instructions which when executed by a processor causes Kalman filtering of data representative of a timing signal and determines calibration data for a wireless access point frequency source.

13. A computer program as recited in claim 12 wherein said timing signal is sourced from a satellite positioning system.

14. A computer program as recited in claim 13 wherein said satellite positioning system consists of GPS, Galileo, GLONASS, NAVSTAR, GNSS or a combination thereof.

15. A system for obtaining service through a secondary network comprising:
a Wi-Fi access point for a network coupled to the Internet, said access point including a clock configured to generate clock timing signals and a filter having a feedback loop coupled to said clock, said filter configured to cause synchronization of said clock timing signals with timing signals received from said secondary network; and
a processor configured to calibrate said clock and forwarding voice and data information to and from said secondary network.

16. A system as recited in claim 15 wherein said secondary network is connected to the Internet.

17. A system as recited in claim 15 wherein said processor is capable of forwarding voice and data information to a mobile station having a wireless transceiver.

18. A system as recited in claim 17 which further includes a server for calculating information consisting of billing, determining access to features, mobile station positioning, navigation directions or a combination thereof, said server being capable of receiving requests from a mobile station consisting of mobile station positioning requests, mobile station navigation requests and a combination thereof.

19. A system as recited in claim 15 wherein said filter is a Kalman filter.

20. A system as recited in claim 15 wherein said network is a Wide Area Network.

21. A system as recited in claim 18 wherein said server is accessible through the Internet.

22. An access point means for providing wireless access to a network comprising:
a clock operable to generate clock timing signals;
recursive filter means coupled to said clock, said filter means being operable to cause synchronization of said clock timing signals with timing signals received from a network connected to the Internet and
a processor being capable of calibrating said clock.
